(19) United States
(12) Patent Application Publication
(10) Pub. No.: US 2024/0238834 A1
(43) Pub. Date: Jul. 18, 2024

(54) TILE EDGE COATING APPARATUS AND METHOD COMPRISING SAME

(71) Applicant: USG INTERIORS, LLC, Chicago, IL (US)

(72) Inventors: Sam Copell, Greenville, MS (US); Hui Zhang, Buffalo Grove, IL (US); Timothy J. Miller, Mundelein, IL (US); Qing Claire Yu, Libertyville, IL (US)

(21) Appl. No.: 18/219,467

(22) Filed: Jul. 7, 2023

Related U.S. Application Data
(60) Provisional application No. 63/480,055, filed on Jan. 16, 2023.

(51) Int. Cl. B05C 13/02; B05C 5/02

(52) U.S. Cl. CPC B05C 13/02; B05C 5/0212

(57) ABSTRACT

An insert for a vacuum coating machine includes a body having a flow channel. The flow channel has a staging chamber, a delivery channel, and a nozzle. The nozzle includes a two-tier step proximate a nozzle exit that is configured to application a coating out of the flow channel and onto a surface.

### FIELD OF THE DISCLOSURE

The disclosure relates generally to coated acoustical tiles and more specifically to an edge coating apparatus and method for vacuum coating acoustical tiles.

### BACKGROUND

Interior walls and ceilings often are covered in decorative and/or functional finishes. For example, walls and ceilings may be painted or covered with panels. One versatile panel covering is a drop tile covering, which is often used in drop or suspended ceilings. Drop tiles are commonly made of materials, such as mineral wool, starch, stucco, plastic, cork, and/or tin. Drop tiles may come indifferent sizes, shapes, and colors. Such tiles often interlock with, or rest upon a grid of metal or plastic runners or straps that are attached to the ceiling with wires. The tiles may have a ledge or flange that rests upon the metal or plastic runners allowing a significant exposed portion to recess down from the grid. While tiles are commonly used in suspended ceilings, tiles may also be used on walls.

In some cases, the tiles described above may be designed with certain acoustical properties that enhance the acoustics of a room or space, these tiles are commonly called acoustic tiles. Acoustic tiles may be designed to absorb sound, to reduce the amount of noise in a room, and/or acoustic tiles may be designed to reflect sound, to improve acoustic properties of a room, for example, in an auditorium. Acoustic tiles are commonly manufactured from some combination of fiberglass, mineral wool, starch and/or other similar materials. Painting or coating the acoustical tiles may help aesthetically, but the paint or coating must not significantly change the acoustical properties of the tiles. Thus, most paint or coating for acoustical tiles is kept very thin to preserve the acoustical properties of the tile. Vacuum coating is one process that results in a thin coating.

### SUMMARY

In a first example, an insert for a vacuum coating machine includes a body having a flow channel. The flow channel has a staging chamber, a delivery channel, and a nozzle. The nozzle includes a two-tier step proximate a nozzle exit that is configured to apply (e.g., spray) a coating out of the flow channel and onto a surface.

In a second example, a combination insert and acoustic tile includes an insert for a vacuum coating machine having a body having a flow channel. The flow channel has a staging chamber, a delivery channel, and a nozzle. The nozzle includes a two-tier step proximate a nozzle exit that is configured to apply (e.g., spray) a coating out of the flow channel and onto a surface. A tile has a first surface and a second surface that are substantially parallel to one another. An edge connects the first surface to the second surface. A flange is formed in the edge. The flange has a flange depth that is substantially parallel to the first surface and to the second surface and a flange height that is substantially perpendicular to the first surface and to the second surface. The two-tier step of the nozzle of the inert has approximately the same height as the flange height.

The above examples of an insert and a combination insert and acoustic tile may further include any one or more of the following optional forms.

In one optional form, the two-tier step includes an angled surface between a first tier and a second tier.

In another optional form, the two-tier step has a maximum depth of between 0.1 in and 0.3 in, preferably approximately 0.22 in.

In yet another optional form, the two-tier step has a maximum height of between 0.2 in and 0.5 in, preferably approximately 0.31 in.

In yet another optional form, the two tier step has a lower depth of between 0.05 in and 0.15 in, preferably approximately 0.12 in, and an upper depth of between 0.05 in and 0.15 in, preferably approximately 0.10 in.

In yet another optional form, the nozzle exit has a height side and a length side, the height side substantially matching the height of an edge of a tile being coated.

In yet another optional form, the flow channel includes a turn upstream of the nozzle, the turn including a first side having an angle of between 90 degrees and 115 degrees, preferably approximately 106 degrees.

In yet another optional form, the turn includes a second side having an angle of between 115 degrees and 130 degrees, preferably approximately 125 degrees.

In yet another optional form, the tile is an acoustic tile.

In yet another optional form, the acoustic tile comprises fiberglass.

In another example, a method of coating a tile includes providing a vacuum coating machine having a coating chamber, an edge coating unit including a coating head, and a vacuum pump. An insert is provided in the coating head, the insert including a body having a flow channel for delivering a coating to an acoustic tile, the flow channel including a staging chamber, a delivery channel, and a nozzle, the nozzle including a two-tier step proximate a nozzle exit. An acoustic tile is provided in the coating chamber, the tile including an upper surface, a lower surface, an edge, and a flange formed in the edge, the flange having a flange depth and a flange height. The two-tier step and the flange in the tile edge are aligned. A coating fluid is forced under pressure through the delivery channel, out of the nozzle, and onto the flange in the tile edge.

The above example of method of coating a tile may further include any one or more of the following optional forms.

In one optional form, the coating fluid has a viscosity of approximately 95 KU, + or −20 KU.

In another optional form, the vacuum pump is operated to produce a pressure in the paint chamber of −0.12 atmosphere + or −50%.

In another optional form, the coating fluid is forced under approximately 1.6 atmospheres, + or −0.5 atmospheres relative to a recommended pressure range for the paint or coating.

In another optional form, the two-tier step includes an angled surface between a first tier and a second tier.

In another optional form, the two-tier step has a maximum depth of between 0.1 in and 0.3 in, preferably approximately 0.22 in.

In another optional form, the two-tier step has a maximum height of between 0.2 in and 0.5 in, preferably approximately 0.31 in.

In another optional form, the flow channel includes a turn upstream of the nozzle, the turn including a first side having an angle of between 90 degrees and 115 degrees, preferably approximately 106 degrees.

In another optional form, the two-tier step is aligned with the flange in the tile edge further includes maintaining a gap of between approximately 1 mm and approximately 2 mm between the nozzle exit and the tile edge.

### BRIEF DESCRIPTION OF THE DRAWINGS

FIG. 1 is a schematic drawing of a vacuum coating machine;

FIG. 2A is a perspective view of two application heads from an application chamber of the vacuum coating machine of FIG. 1 and a tile being coated by the two application heads;

FIG. 2B is a top view of the two application heads and tile of FIG. 2A;

FIG. 2C is a side view of the two application heads and tile of FIG. 2A;

FIG. 2D is a bottom view of the two application heads and tile of FIG. 2A;

FIG. 3A is a close up perspective view of one of the application heads of FIG. 2A;

FIG. 3B is a transparent perspective view of the application head of FIG. 3A;

FIG. 3C is a top view of the application head of FIG. 3A;

FIG. 3D is a side view of the application head of FIG. 3A;

FIG. 3E is a bottom view of the application head of FIG. 3A;

FIG. 3F is a cross-sectional view of the application head of FIG. 3A taken along section line F-F in FIG. 3D;

FIG. 3G is a close-up bottom view of the application head of FIG. 3A, showing an insert;

FIG. 4A is a bottom view of a prior art insert that may be used in the application head of FIGS. 2A, 2B, 2C, and 3;

FIG. 4B is a first side view of the prior art insert of FIG. 4A;

FIG. 4C is a top view of the prior art insert of FIG. 4A;

FIG. 4D is a second side view of the prior art insert of FIG. 4A;

FIG. 5A is a bottom view of an insert that may be used in the application head of FIGS. 2A, 2B, 2C, and 3, the insert being constructed in accordance with the teachings of the disclosure;

FIG. 5B is a first side view of the insert of FIG. 5A;

FIG. 5C is a top view of the insert of FIG. 5A;

FIG. 5D is a second side view of the insert of FIG. 5A;

FIG. 6 is a close up partial perspective view of an exit nozzle of the insert of FIGS. 5A-5D; and

FIG. 7 is a close up perspective view of the exit nozzle of FIG. 6 in an operational position with a tile.

### DETAILED DESCRIPTION

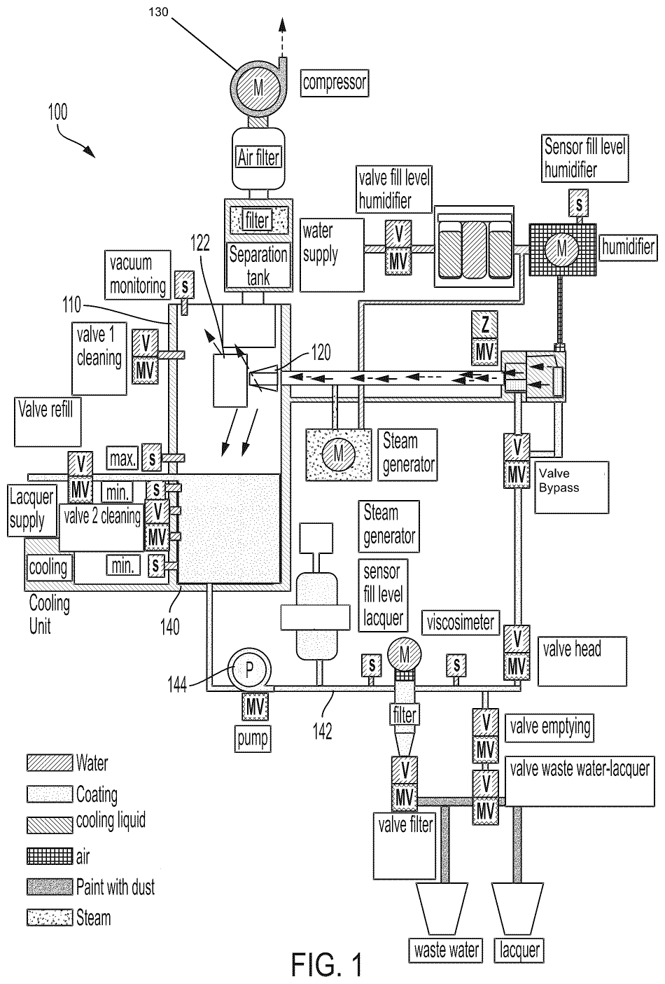

Turning now to the FIG. 1, one example of a vacuum coating machine 100 is illustrated, which is representative of a DVC TALENT GAMMA coater manufactured by Cefla™ Deutschland GmbH, Meckenheim Germany. The vacuum coating machine 100 includes a vacuum paint (or coating) chamber 110. The vacuum paint chamber 110 includes an application head 120 that applies paint or coating onto a tile 122 such as, for example, an acoustic ceiling tile. A vacuum pump 130 creates a partial vacuum in the vacuum chamber 110. In some embodiments, the vacuum pump 130 is operated to create a pressure in the paint chamber 110 of approximately −0.12 atmospheres, + or −50%.

Paint or coating is pumped from a paint or coating reservoir 140, through a paint or coating line 142 to the application head 120 by a paint or coating pump 144 as a series of tiles 122 are moved past the application head 120. The paint or coating pump 144 may be operated in some embodiments to produce a pressure of approximately 1.6 atmospheres, + or −0.5 atmosphere relative to a recommended pressure for the paint or coating. In some embodiments, the paint or coating may have a viscosity of approximately 75 KU (Krebs units), + or −40 KU.

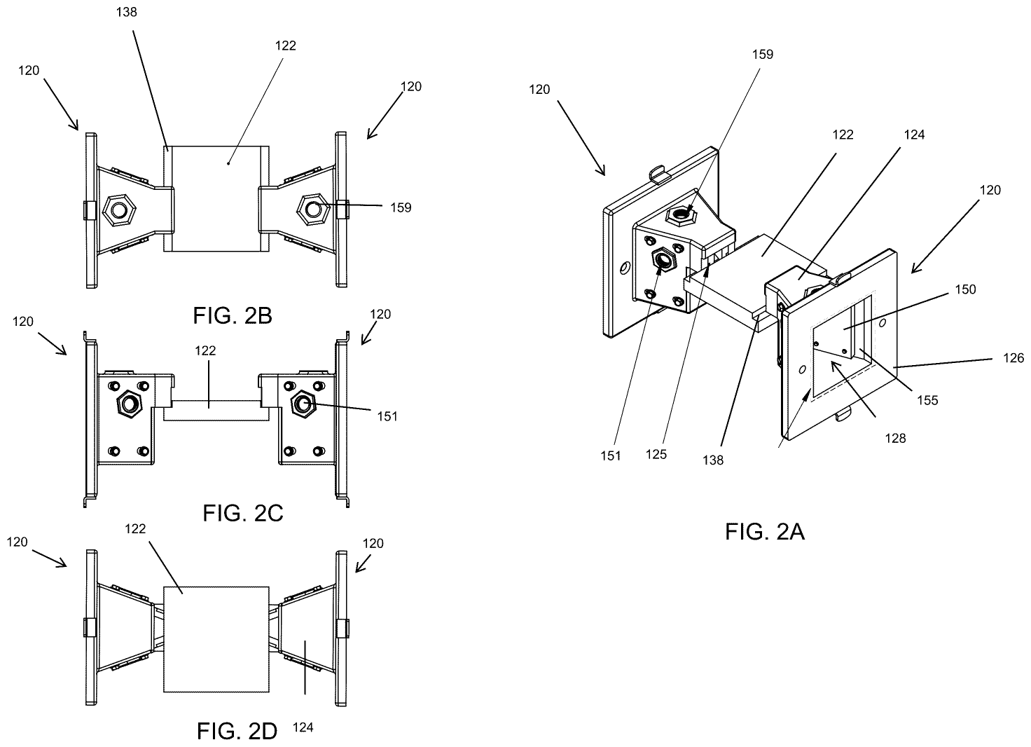

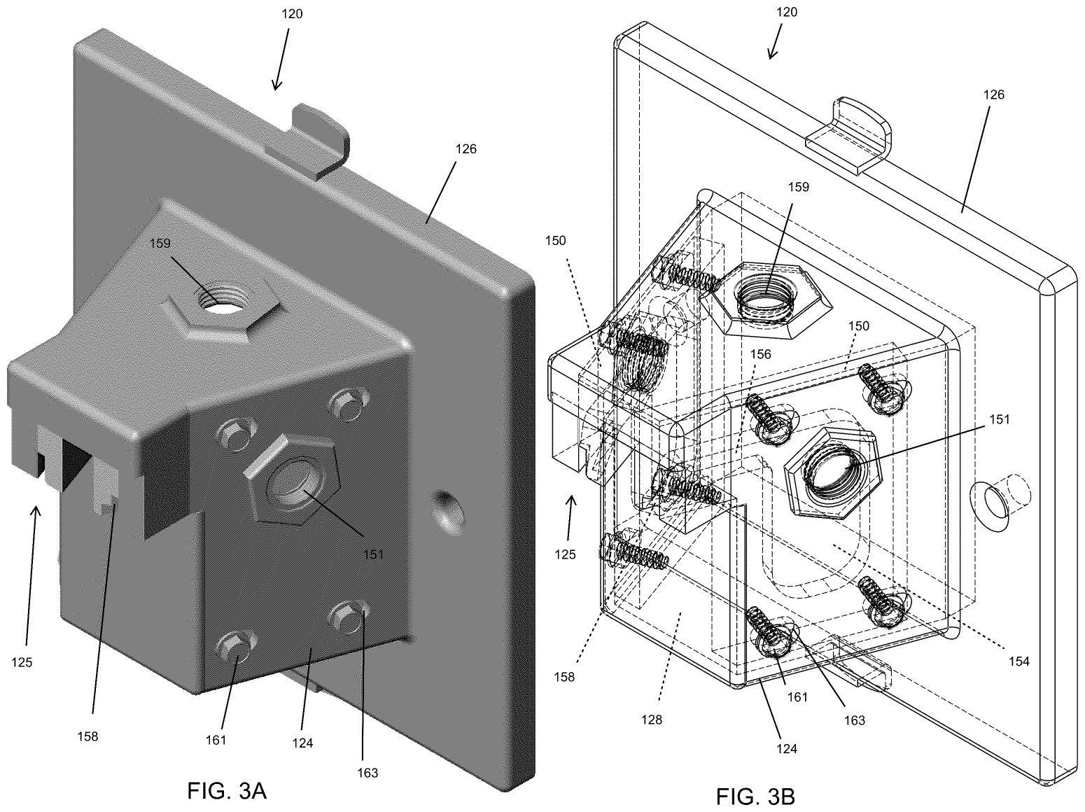

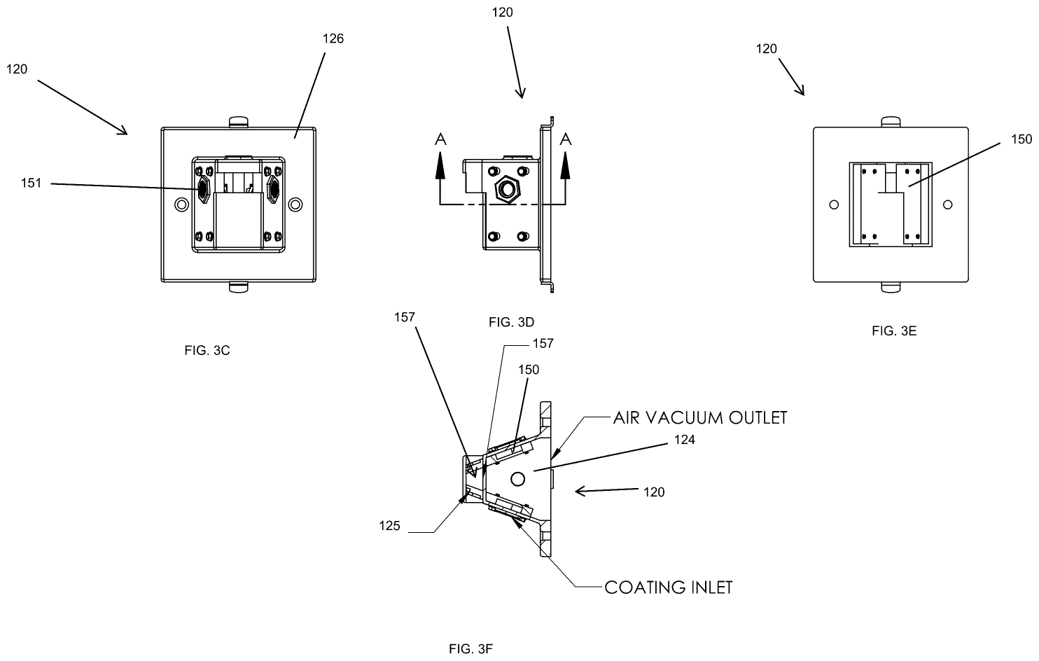

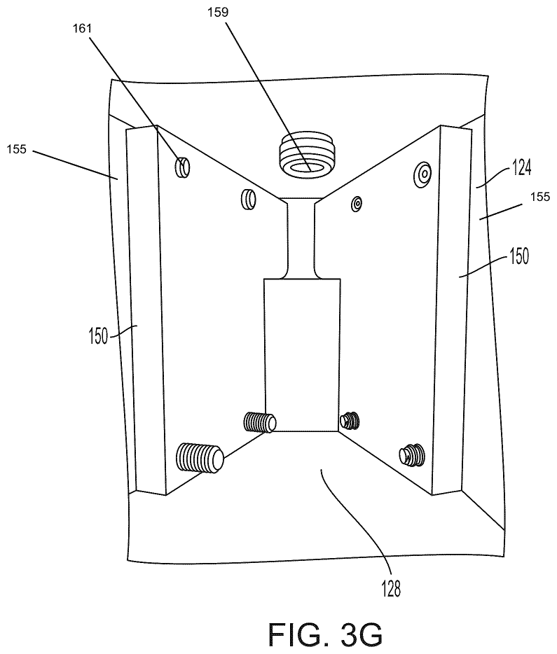

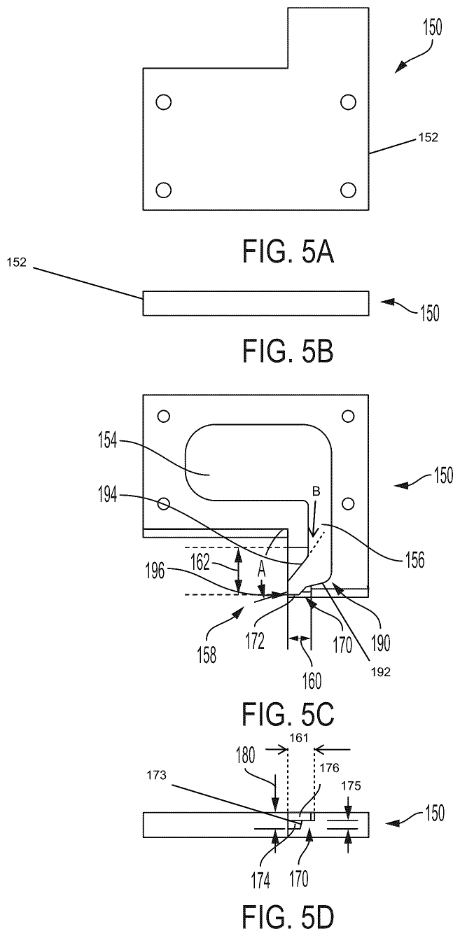

Turning now to FIGS. 2A-2D and 3A—3G, the application head 120 includes an application projector portion 124 and an attachment flange 126. A tile, for example an acoustic tile 122, is positioned proximate an outlet 125 of the projector portion 124. More specifically, the acoustic tile 122 has a flange 138 (which is discussed further below) positioned proximate the outlet 125 so that paint or coating may be projected onto the flange 138 from the outlet 125. The application projector portion 124 has a hollow interior 128 for receiving one or more inserts 150 (illustrated in dashed lines in the application head 120 in FIG. 3B as the one or more inserts 150 are located within the application projector portion 124 and better viewed from the underside of the head 120 in FIGS. 3E and 3G). The inserts 150 control the application characteristics (e.g., direction, flow, etc.) of the paint or coating as it is applied to the tile 122. More specifically, paint or coating is introduced into the application head 120 through one or more application ports 151. A semi vacuum or area of reduced pressure is produced in the hollow interior 128 of the projector portion 124 by attaching the vacuum pump 130 (FIG. 1) or other pressure reducing device, to a vacuum inlet 157. The paint or coating flows into the head 120 from a supply line (not shown) connected to the one or more application ports 151. A pressure balancing port 159 may introduce additional paint or coating if needed to balance the internal pressure of the hollow interior 128. As will be described more fully below, the paint or coating then passes through a staging chamber 154 (seen in FIGS. 3B, 5C, and 5D), a flow channel 156 (seen in FIGS. 3B, 5C, and 5D), and a nozzle 158 (seen in FIGS. 3B, 5C, and 5D) formed in an inner surface of the one or more inserts 150, thus disposed between the inner surface of the one or more inserts 150 and an interior surface 155 of a wall 153 of the application projector portion 124. Referring back to FIGS. 3A, 3B, and 5C, the paint or coating is dispensed from the nozzle 158, out of the outlet 125, and onto the flange 138 of the acoustic tile 122. A plurality of fasteners 161 may secure the insert 150 to the interior surface 155 of the wall 153 through one or more fastener openings 163.

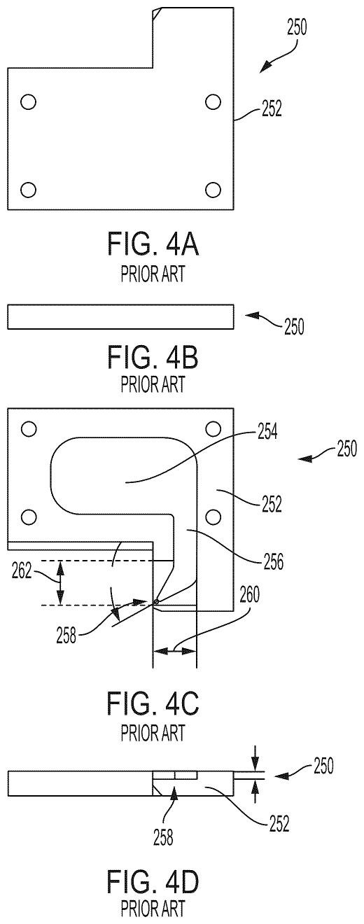

FIGS. 4A-4D illustrate a prior art insert 250. The prior art insert 250 includes an insert body 252. The insert body 252 includes a recessed staging chamber 254, a recessed delivery or flow channel 256, and a recessed nozzle 258. When the insert body 252 is inserted in the application head 120 and held against an interior surface of the application head 120, the recessed staging chamber 254, the recessed delivery or flow channel 256, and the recessed nozzle 258 form a flow pathway for the paint or coating, similar to that described above. The recessed nozzle 258 includes a height 260 and a width 262. Prior art inserts, for example the prior art insert 250 of FIGS. 4A-4D, had a problem of over-application of the paint or coating onto a first surface or onto a second surface of the tile 122. This over-application created a ridge on the first surface or the second surface. This ridge was aesthetically unpleasing, in fact, this ridge, if pronounced enough, could cause a consumer to think the tile 122 was defective. Additionally, the ridge was a waste of paint or coating. The over-application was excess paint that was not recovered, and tiles 122 having a ridge often needed post coating treatment to remove or reduce the ridge, which created additional waste.

Turning now to FIGS. 5A-5D, an insert 150 according to the teachings of the present disclosure is illustrated. The insert 150 may be used in the application head 120 of the vacuum coating machine 100 illustrated in FIG. 1. In other embodiments, the insert 150 may be used in other vacuum painting or coating machines. The insert 150 includes an insert body 152. The insert body includes a recessed staging chamber 154, a recessed delivery or flow channel 156, and a recessed nozzle 158. When the insert body 152 is inserted into the application head 120 and held against an interior surface of the application head 120, the recessed staging chamber 154, the recessed delivery or flow channel 156, and the recessed nozzle 158 form a flow pathway for the paint or coating. The nozzle 158 includes a two-tier step 170 proximate a nozzle exit 172 that is configured to dispense a paint or coating out of the delivery or flow channel 156 and onto a surface, for example, onto a surface of a tile 122.

As shown in FIG. 5D, the two-tier step 170 includes an angled surface 173 between a first tier 174 and a second tier 176. In some embodiments, the angled surface 173 may be angled between 100 and 115 degrees relative to the first tier 174 and the second tier 176. The two-tier step has a maximum depth 180 of between 0.1 in and 0.3 in, preferably approximately 0.22 in. Other dimensions are possible.

As shown in FIG. 5D, the two-tier step 170 has a maximum height 161 of between 0.2 in and 0.5 in, preferably approximately 0.31 in. Other dimensions are possible.

The two-tier step 170 has a lower portion (first tier 174) having a depth 175 of between 0.05 in and 0.15 in, preferably approximately 0.12 in, and an upper portion (second tier 176) having a depth of between 0.05 in and 0.15 in, preferably approximately 0.10 in. Other dimensions are possible.

Referring to FIG. 5C, the nozzle exit 172 has a height 160 and a width 162, the height 160 corresponds to the maximum height 161 of the two-tier step 170 discussed above. The height 160 of the nozzle exit 172 substantially matches the height of an edge of a tile 122 being coated, as will be further discussed below.

As shown in FIG. 5C, the flow channel 156 includes a turn 190 upstream of the nozzle 158. The turn 190 includes a first side 192 that is angled relative to the upstream flow channel 156 by an angle A of between approximately 90 degrees and approximately 115 degrees, and in some versions approximately 106 degrees. Other angles are possible. The turn 190 includes a second side 194 that is angled relative to an upstream flow channel 156 by an angle B of between approximately 115 degrees and approximately 130 degrees, and in some versions approximately 125 degrees. Other angles are possible. In the disclosed version the angle B of the second side 194 is larger than the angle A of the first side 192. Other relationships, however, are possible. So configured, the disclosed flow channel 156 and nozzle 158 advantageously focus the flow or direct the flow of the paint or coating application towards a corner 196 of the nozzle 158, which in turn focuses the application to a desired corner of a ledge on the tile 122.

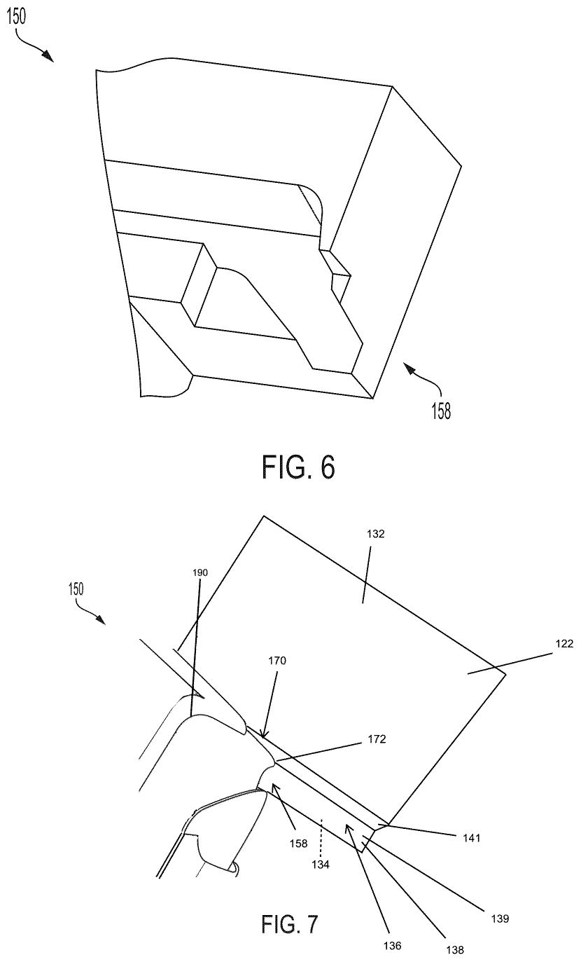

Turning now to FIGS. 6 and 7, the insert 150 is illustrated relative to an acoustic tile 122. The acoustic tile 122 has a first surface 132 and a second surface 134 that are substantially parallel to one another. In one embodiment, the first surface 132 is a bottom surface, viewable to the consumer when the acoustic tile 122 is installed in a drop ceiling grid system. An edge 136 connects the first surface 132 to the second surface 134. A flange 138 is formed in the edge 136. The flange 138 has a flange depth 139 that is substantially parallel to the first surface 132 and to the second surface 134 and a flange height 141 that is substantially perpendicular to the first surface 132 and to the second surface 134. As discussed above, the two-tier step 170 of the nozzle 158 of the inert 150 has approximately the same height 161 as the flange height 141. During painting or coating, the two-tier step 170 is aligned with the flange 138 in the tile edge 136 and a gap of between approximately 1 mm and approximately 2 mm is maintained between the nozzle exit 172 and the flange 138 of the tile edge 136. As can be seen in FIG. 7, the turn 190 in the flow channel 156 in combination with the two-tier step 170 directs the coating down toward the flange 138 while covering the entire surface that constitutes the flange height 141, without extending up beyond the first surface 132. This advantageously prevents the coating or paint from creating the undesirable ridge on the corner of the first surface 132 adjacent the flange height 141 as the tile 122 moves past the insert 150.

The acoustic tile may be made of any sound characterizing material, such as fiberglass and mineral-wool.

The devices (and methods) for painting or coating an acoustic tile described above may be advantageously allow the paint or coating to be more focused along the flange or edge of the tile, which results in less over-application and less ridging.

While various embodiments have been described herein, it will be understood that modifications may be made thereto that are still considered within the scope of the appended claims.

1. An insert for a vacuum coating machine, the insert comprising:
a body having a flow channel, the flow channel including a staging chamber, a delivery channel, and a nozzle, the nozzle including a two-tier step proximate a nozzle exit configured to application a coating out of the flow channel and onto a surface.

2. The insert of claim 1, wherein the two-tier step includes an angled surface between a first tier and a second tier.

3. The insert of claim 1, wherein the two-tier step has a maximum depth of between 0.1 in and 0.3 in, preferably approximately 0.22 in.

4. The insert of claim 1, wherein the two-tier step has a maximum height of between 0.2 in and 0.5 in, preferably approximately 0.31 in.

5. The insert of claim 4, wherein the two tier step has a lower depth of between 0.05 in and 0.15 in, preferably approximately 0.12 in, and an upper depth of between 0.05 in and 0.15 in, preferably approximately 0.10 in.

6. The insert of claim 1, wherein the nozzle exit has a height side and a length side, the height side substantially matching the height of an edge of a tile being coated.

7. The insert of claim 1, wherein the flow channel includes a turn upstream of the nozzle, the turn including a first side having an angle of between 90 degrees and 115 degrees, preferably approximately 106 degrees.

8. The insert of claim 7, wherein the turn includes a second side having an angle of between 115 degrees and 130 degrees, preferably approximately 125 degrees.

9. A combination insert and acoustic tile, the combination comprising:
the insert of claim 1; and
a tile, the tile including a first surface, a second surface, the first surface and the second surface being substantially parallel to one another, an edge connecting the first surface to the second surface, and a flange formed in the edge, the flange having a flange depth that is substantially parallel to the first surface and to the second surface and a flange height that is substantially perpendicular to the first surface and to the second surface,
wherein the two-tier step of the nozzle of the inert is approximately the same height as the flange height.

10. The combination of claim 9, wherein the tile is an acoustic tile.

11. The combination of claim 10, wherein the acoustic tile comprises fiberglass

12. A method of coating a tile, the method comprising:
providing a vacuum coating machine comprising a coating chamber, an edge coating unit including a coating head, and a vacuum pump;
providing an insert in the coating head, the insert including a body having a flow channel for delivering a coating to an acoustic tile, the flow channel including a staging chamber, a delivery channel, and a nozzle, the nozzle including a two-tier step proximate a nozzle exit;
providing the acoustic tile in the coating chamber, the tile including an upper surface, a lower surface, an edge, and a flange formed in the edge, the flange having a flange depth and a flange height;
aligning the two-tier step with the flange in the tile edge; and
forcing a coating fluid under pressure through the delivery channel, out of the nozzle, and onto the flange in the tile edge.

13. The method of claim 12, wherein the coating fluid has a viscosity of approximately 75 KU, + or −40 KU.

14. The method of claim 12, further comprising operating the vacuum pump to produce a pressure in the paint chamber of approximately −0.12 atmosphere, + or −50%.

15. The method of claim 12, further comprising forcing the coating fluid under approximately 1.6 atmospheres, + or −0.5 atmosphere relative to a recommended pressure for the coating fluid.

16. The method of claim 12, wherein the two-tier step includes an angled surface between a first tier and a second tier.

17. The method of claim 12, wherein the two-tier step has a maximum depth of between 0.1 in and 0.3 in, preferably approximately 0.22 in.

18. The method of claim 12, wherein the two-tier step has a maximum height of between 0.2 in and 0.5 in, preferably approximately 0.31 in.

19. The method of claim 12, wherein the flow channel includes a turn upstream of the nozzle, the turn including a first side having an angle of between 90 degrees and 115 degrees, preferably approximately 106 degrees.

20. The method of claim 12, wherein aligning the two-tier step with the flange in the tile edge further includes maintaining a gap of between 1 mm and 2 mm between the nozzle exit and the tile edge.
